(19) United States
(12) Patent Application Publication
(10) Pub. No.: US 2025/0353496 A1
(43) Pub. Date: Nov. 20, 2025

(54) DYNAMIC FOLLOW GAP ADJUSTMENT IN VARIANT TRAFFIC CONDITIONS

(71) Applicant: GM Global Technology Operations LLC, Detroit, MI (US)

(72) Inventors: Paul A. Adam, Milford, MI (US); Jeffrey Scott Parks, Ann Arbor, MI (US)

(73) Assignee: GM Global Technology Operations LLC, Detroit, MI (US)

(21) Appl. No.: 18/663,717

(22) Filed: May 14, 2024

(51) Int. Cl. B60W 30/16; B60W 30/14

(52) U.S. Cl. CPC B60W 30/16; B60W 30/143; B60W 2554/4046; B60W 2554/406; B60W 2554/408; B60W 2554/80

(57) ABSTRACT

A computer-implemented method that, when executed by data processing hardware, causes the data processing hardware to perform operations comprising gathering sensor data from a sensor system of a host vehicle, evaluating sensor data, determining surrounding road conditions and behavior of a lead vehicle, receiving a first follow gap selected by the driver, calculating a second follow gap based on the surrounding road conditions and the behavior of the lead vehicle, adjusting host vehicle acceleration profile using the second follow gap while maintaining at least the first gap between the host vehicle and a lead vehicle, monitoring behavior of road actors in one or more adjacent lanes, and adjusting the second gap based on the behavior of the road actors in the one or more adjacent lanes.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to method of controlling a vehicle with an advanced driver assistance system.

In general, a host vehicle can be equipped with an advanced driver assistance system (ADAS) that helps maintain control of the host vehicle. Some features or aspects of the ADAS are configured to maintain a set distance between a host vehicle and a lead vehicle. Existing systems are configured so that the host vehicle chases or mimics behavior of the lead vehicle and this can lead to harsh or jerky acceleration profiles that negatively affect a driving experience of one or more passengers of the host vehicle. Shortcomings of existing systems and methods are addressed by one or more aspects of the present disclosure.

### SUMMARY

In one configuration, a computer-implemented method that, when executed by data processing hardware, causes the data processing hardware to perform operations is provided. The operations include gathering sensor data from a sensor system of a host vehicle, evaluating the sensor data, determining surrounding road conditions and behavior of a lead vehicle, receiving a first follow gap selected by a driver, calculating a second follow gap based on the surrounding road conditions and the behavior of the lead vehicle, adjusting an acceleration profile of the host vehicle using the second follow gap while maintaining at least the first follow gap between the host vehicle and the lead vehicle, monitoring behavior of road actors in one or more adjacent lanes, and adjusting the second follow gap based on the behavior of the road actors in the one or more adjacent lanes.

The method may include one or more of the following optional aspects or steps. For example, the surrounding road conditions and behavior of the lead vehicle can further include evaluating a host vehicle velocity, a first target follow distance time, and a rate of change of the host vehicle with a road condition assessment module. The road condition assessment module can be configured to provide an adjusted time gap. Calculating the second follow gap can further include evaluating the adjusted time gap, the first follow gap, and a minimum allowable gap with a buffer evaluation module. The buffer evaluation module can be configured to provide a second target follow distance time. Calculating the second follow gap can further include evaluating the second target follow distance time and an oscillatory gain with a predictive logic module.

According to at least one aspect, the second follow gap can be continuously calculated according to the surrounding road conditions and behavior of the lead vehicle. The second follow gap can be reduced when one or more road actors cut in between the lead vehicle and the host vehicle. The second follow gap can be increased when road conditions are highly variable. The second follow gap can be maintained when road conditions are consistent.

In another configuration, a system including data processing hardware and memory hardware in communication with the data processing hardware is provided. The memory hardware storing instructions that, when executed on the data processing hardware, cause the data processing hardware to perform operations. The operations include gathering sensor data from a sensor system of a host vehicle, evaluating the sensor data, determining surrounding road conditions and behavior of a lead vehicle, receiving a first follow gap selected by a driver, calculating a second follow gap based on the surrounding road conditions and the behavior of the lead vehicle, adjusting an acceleration profile of the host vehicle using the second follow gap while maintaining at least the first follow gap between the host vehicle and the lead vehicle, monitoring behavior of road actors in one or more adjacent lanes, and adjusting the second follow gap based on the behavior of the road actors in the one or more adjacent lanes.

The system may include one or more of the following optional aspects or steps. For example, the second follow gap can be continuously calculated according to the surrounding road conditions and behavior of the lead vehicle. The second follow gap can be reduced when one or more road actors cut in between the lead vehicle and the host vehicle. The second follow gap can be increased when road conditions are highly variable. The second follow gap can be maintained when road conditions are consistent.

In yet another configuration, a computer-implemented method that, when executed by data processing hardware, causes the data processing hardware to perform operations is provided. The operations include determining a traffic condition status, disabling a buffer management system if the traffic condition status indicates consistent traffic surrounding a host vehicle, activating the buffer management system if the traffic condition status indicates variable traffic surrounding the host vehicle, determining whether road actor cut-ins are present between the host vehicle and a lead vehicle, and either generating (i) a first buffer if the road actor cut-ins are present or (ii) a second buffer if the road actor cut-ins are not present.

The method may include one or more of the following optional aspects or steps. For example, the first buffer can further include a preferred follow distance time and a cut-in buffer time. The cut-in buffer can be absorbed if one or more thresholds are met and reestablished if the one or more thresholds are not met.

According to at least one aspect, the second buffer can further include a preferred follow distance time and a non-cut-in buffer time. The non-cut-in buffer time can be absorbed if one or more thresholds are met and reestablished if the one or more thresholds are not met.

### BRIEF DESCRIPTION OF THE DRAWINGS

The drawings described herein are for illustrative purposes only of selected configurations and are not intended to limit the scope of the present disclosure.

FIG. 1 is a schematic diagram of a vehicle environment including a vehicle management system according to principles of the present disclosure;

FIG. 2 is an enlarged schematic diagraming showing an example of the vehicle management system of FIG. 1 according to the principles of the present disclosure;

FIG. 3 is a flow diagram showing operations of the vehicle management system of FIG. 2; and

FIG. 4 is a flow diagram showing operations of the vehicle management system of FIG. 2.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

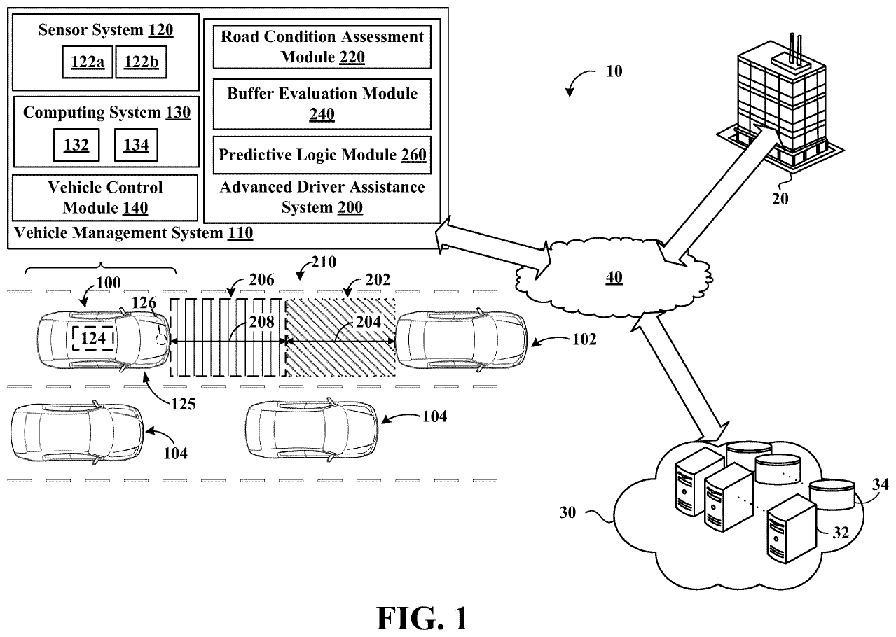

Referring to FIG. 1, an example vehicle operating environment 10 is provided for illustration of the principles of the present disclosure. The vehicle operating environment 10 includes a vehicle service center 20. For the sake of illustration, the vehicle operating environment 10 is shown as including a single vehicle service center 20. However, in other examples, the vehicle operating environment 10 may include a plurality of vehicle service centers 20 in communication over a network 40 (e.g., the Internet, cellular networks).

The vehicle operating environment 10 includes a host vehicle 100, a lead vehicle 102, and one or more nearby road actors 104. The host vehicle 100 includes a vehicle management system 110 including a sensor system 120, a computing system 130, a vehicle control module 140, and an advanced driver assistance system (ADAS) 200. The vehicle management system 110 may be configured to gather information concerning surrounding traffic conditions and adjust control of the host vehicle 100 accordingly.

While the host vehicle 100 maneuvers about the environment 10, the sensor system 120 includes various sensor subsystems 122, 122a-122b configured to gather sensor data 123, 123a-123b relating to characteristics of the environment 10 and/or a status of the host vehicle 100. The sensor subsystems 122 can include an ADAS sensor subsystem 122a configured to measure or obtain vehicle operating and/or vehicle position data 123a. The ADAS sensor subsystem 122a can include an inertial measurement unit (IMU) 124, one or more wheel speed sensors 125, one or more cameras 126, and other sensors for obtaining vehicle data 123a. The sensor subsystems 122 can also include and a vehicle exterior sensor subsystem 122d configured to measure or obtain external environmental data 123b, such as surrounding objects (e.g., vehicles, pedestrians). The vehicle exterior sensor subsystem 122b can include one or more of an RGB camera, an infrared camera, a thermal camera, a radar, and/or an external microphone, for example.

As the sensor system 120 gathers the sensor data 123, a computing system 130 is configured to store, process, and/or communicate the sensor data 123 within the vehicle operating environment 10. In order to perform computing tasks related to the sensor data 123, the computing system 130 of the host vehicle 100 includes data processing hardware 132 and memory hardware 134. The data processing hardware 132 is configured to execute instructions stored in the memory hardware 134 to perform computing tasks related to operation and management of the host vehicle 100. Generally speaking, the computing system 130 refers to one or more locations of data processing hardware 132 and/or memory hardware 134.

In some examples, the computing system 130 is a local system located on the host vehicle 100. When located on the host vehicle 100, the computing system 130 may be centralized (i.e., in a single location/area on the host vehicle 100), decentralized (i.e., located at various locations about the host vehicle 100), or a hybrid combination of both (e.g., with a majority of centralized hardware and a minority of decentralized hardware). To illustrate some differences, a decentralized computing system 130 may allow processing to occur at an activity location while a centralized computing system 130 may allow for a central processing hub that communicates to systems located at various positions on the host vehicle 100.

Additionally or alternatively, the computing system 130 includes computing resources that are located remotely from the host vehicle 100. For instance, the computing system 130 may communicate via the network 40 with a remote vehicle computing system 30 (e.g., a remote computer/server or a cloud-based environment). Much like the computing system 130, the remote vehicle computing system 30 includes remote computing resources such as remote data processing hardware 32 and remote memory hardware 34. Here, sensor data 123 or other processed data (e.g., data processing locally by the computing system 130) may be stored in the remote vehicle computing system 30 and may be accessible to the computing system 130. In some examples, the computing system 130 is configured to utilize the remote resources 32, 34 as extensions of the computing resources 132, 134 such that resources of the computing system 130 may reside on resources of the remote vehicle computing system 30.

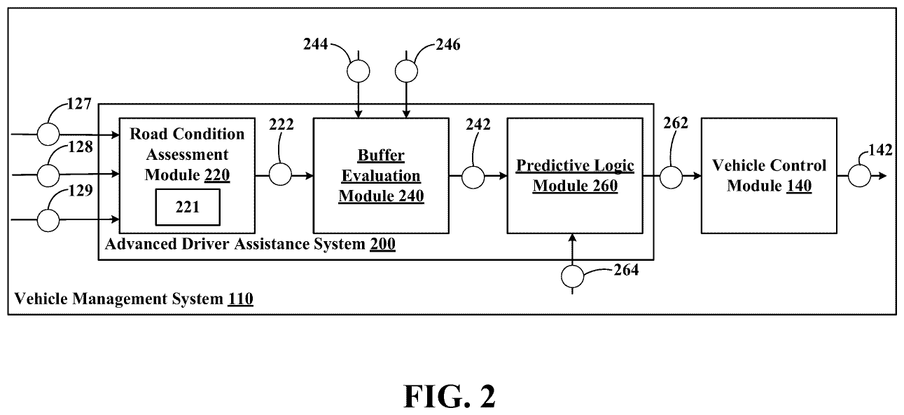

With reference to FIGS. 1 and 2, the vehicle management system 110 includes the advanced driver assistance system (ADAS) 200 which is capable of monitoring and controlling one or more electronic aspects of the host vehicle 100 and monitoring and controlling one or more subsystems of the host vehicle 100. For instance, as discussed in more detail below, the ADAS 200 can communicate with the vehicle control module 140 in order to adjust an acceleration profile of the host vehicle 100 based on surrounding traffic conditions, behavior of the lead vehicle 102, or behavior of the one or more nearby road actors 104.

Ordinarily, certain ADAS 200 features (e.g., adaptive cruise control) allow drivers to select a first or preferred follow gap (e.g., close, medium, far) 202 (FIG. 1) which can be used by the ADAS 200 to maintain a certain distance or an amount of time 204 between the host vehicle 100 and the lead vehicle 102. In stop-and-go traffic conditions, existing systems can produce harsh or jerky acceleration and deceleration profiles, as existing vehicle are typically configured to chase or mimic behavior of the lead vehicle 102. According to at least one aspect of the present disclosure, the ADAS 200 can include one or more modules for evaluating and/or storing sensor data 123 of the sensor system 120 and provide instructions to one or more of the systems (e.g., the vehicle control module 140) of the host vehicle 100 to provide a more comfortable driving experience by minimizing motion profile extremes while providing general compliance to the driver's preferred follow gap 202. For instance, the ADAS 200 can include a road condition assessment module 220, a buffer evaluation module 240, and a predictive logic module 260.

In general, the ADAS 200 may be configured to calculate an absorption region or second follow gap 206 which allows for a buffer distance or time 208 between the host vehicle 100 and the lead vehicle 102. The second follow gap 206 can be continuously and instantaneously adjusted during travel of the host vehicle 100. The second follow gap 206 may be desirable to provide a more comfortable driving experience in highly unstable traffic conditions and/or when one or more of the nearby road actors 104 cut in between the host vehicle 100 and the lead vehicle 102, for example. Note, the first follow gap 202 and the second follow gap 206 may be collectively referred to as the follow gap 210 through the description.

With reference to FIG. 2, the road condition assessment module 220 can be configured to evaluate road conditions (i.e., traffic conditions) and determine whether the road conditions are consistent (i.e., steady and smooth travel) or highly variable (i.e., stop-and-go). In other words, the road condition assessment module 220 can be configured to consider the road conditions surrounding the host vehicle 100, behavior of the lead vehicle 102, measures of mean velocity and acceleration profiles, variability in traffic conditions, period, and frequency of change in conditions. According to at least one aspect, the road condition assessment module 220 can calculate an adjusted time gap 222 based on host vehicle velocity 127, a first target follow distance time (i.e., an initial target follow distance time) 128, and a rate of change 129 of the host vehicle. In one example, the adjusted time gap 222 can be determined by using a look up table 221 with the host vehicle velocity 127, the first target follow distance time 128, and the rate of change 129.

The buffer evaluation module 240 can be configured to determine a second target follow distance time (i.e., an adjusted target follow distance time) 242. In some instances, the second target follow distance time will increase the follow gap 210 between the host vehicle 100 and the lead vehicle 102 and in other instances, will decrease the follow gap 210 between the host vehicle 100 and the lead vehicle 102. According to at least one aspect, the second target follow distance time 242 can be determined by summing the adjusted time gap 222, a driver selected gap 244, and a minimum allowable follow gap 246.

Based on the observed behavior of the surrounding road conditions and behavior of the lead vehicle 102, the predictive logic module 260 can receive the second target follow distance time 242 and adjust or modify it accordingly. For instance, a target oscillatory gain 264 can be applied to the second target follow distance time 242 to determine a third or final target follow distance time 262. The third target follow distance time 262 is predictive in nature and can help prevent sudden motion (i.e., jerk) during instances of acceleration and deceleration.

With continued reference to FIG. 2, the vehicle control module 140 can be configured to receive the third target follow distance time 262 and communicate instructions 142 to one or more systems of the host vehicle 100. In some instances, the third target follow distance time 262 can be referred to as a follow gap modifier since the third target follow distance time 262 can be relied on to reduce harsh or jerky motion while maintaining a satisfactory following distance between the host vehicle 100 and the lead vehicle 102.

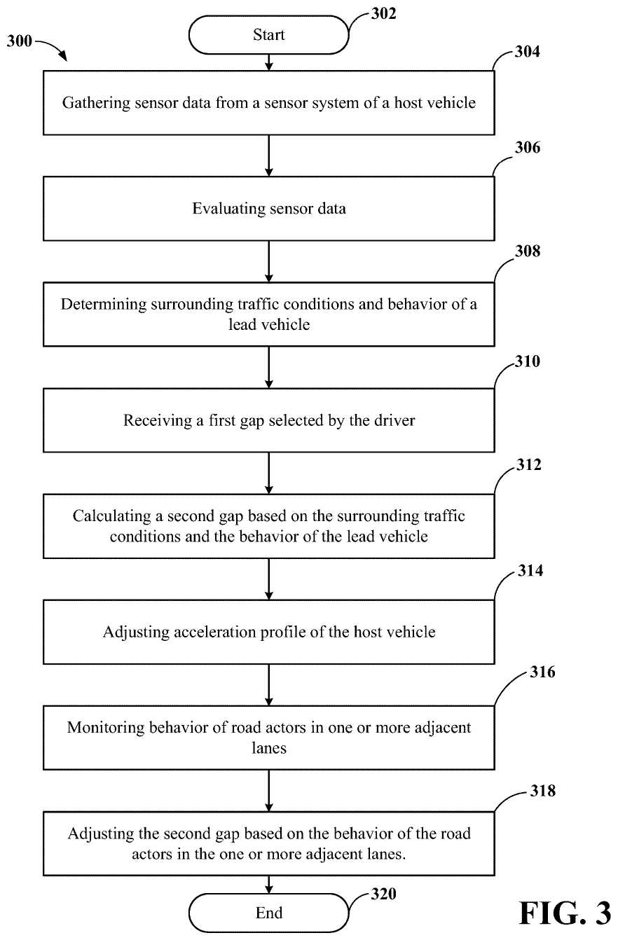

With reference to FIG. 3, a method 300 is provided for dynamically adapting the follow gap 210 based on surrounding road conditions and the behavior of the lead vehicle 102. At 302, the method 300 is initiated. In practical terms, the method 300 is initiated when the driver or the host vehicle 100 enables one or more ADAS features (e.g., adaptive cruise control).

At 304, sensor data 123 can be gathered from one or more sensors of the sensor subsystems 122.

At 306, the sensor data 123 can be evaluated. For instance, the sensor data 123 can be evaluated by the computer system 130 which may be configured with a perception system that can use the sensor data 123 to identify surrounding objects such as vehicles (i.e., the lead vehicle and/or the one or more nearby road actors 104) or pedestrians, for example.

At 308, the surrounding road conditions and the behavior of the lead vehicle 102 can be determined using the road condition assessment module 220 of the ADAS 200. In general, the road condition assessment module 220 can be configured to determine whether the surrounding road conditions and/or the behavior of the lead vehicle 102 is consistent or highly variable.

At 310, the first follow gap 202 may be selected by the driver of the host vehicle 102 and be received at the ADAS 200. Note, this step can also happen simultaneously or shortly after the method 300 is initiated at 302.

At 312, the second follow gap 206 can be calculated based on the surrounding road conditions and the behavior of the lead vehicle 102. If the road conditions are highly variable, then the second follow gap 206 can be increased. If the road conditions are consistent, then the second follow gap can be maintained.

At 314, the acceleration profile of the host vehicle 100 can be adjusted with the second follow gap 206 while at least maintaining the first follow gap 202 between the host vehicle 100 and the lead vehicle 102.

At 316, the behavior of one or more nearby road actors 104 is monitored to determine whether one or more of the nearby road actors 104 is cutting in between the host vehicle 100 and the lead vehicle 102.

At 318, if one or more of the nearby road actors 104 cuts in between the host vehicle 100 and the lead vehicle 102 the second follow gap 206 can be adjusted (e.g., decreased) based on this behavior. In other words, the second follow gap can be used to absorb sudden changes in the follow gap distance and remove harsh or jerky deceleration profiles of the host vehicle 100.

At 320, the method 300 ends.

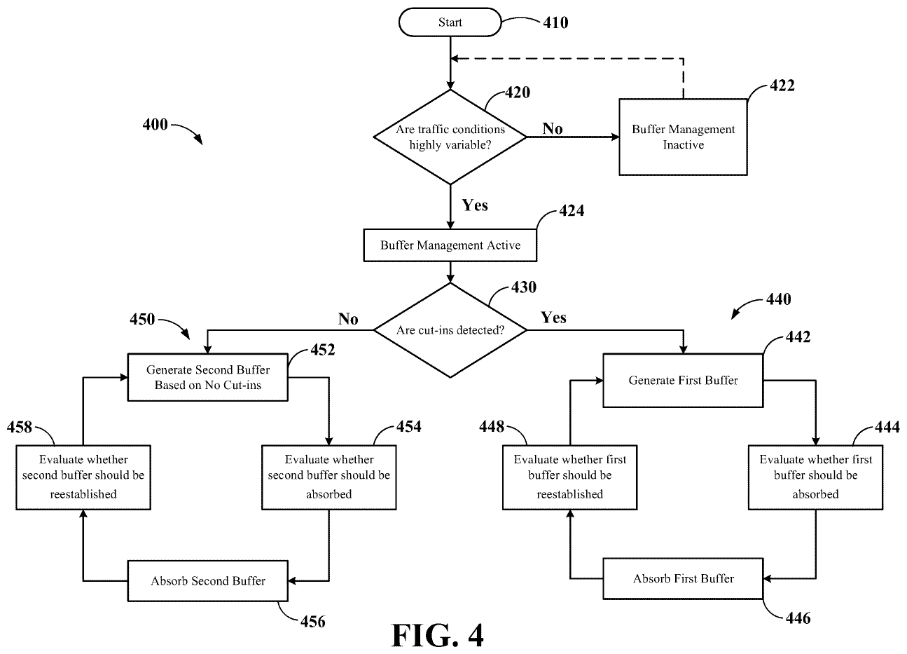

With reference to FIG. 4, a method 400 is provided for dynamically adapting the follow distance time based on vehicle dynamics of a closest in path vehicle (e.g., the lead vehicle 102). At 410, the method 400 is initiated. In practical terms, the method 400 is initiated when the driver or operator powers on the host vehicle 100.

At 420, a traffic condition status can be evaluated to determine whether conditions are consistent or highly variable (i.e., stop-and-go traffic) surrounding the host vehicle 100. The traffic condition status can be determined based on one or more conditions.

At 422, if the traffic condition status indicates that the traffic conditions are not highly variable then a buffer management system can remain inactive.

At 424, if the traffic condition status indicates that the traffic conditions are highly variable then the buffer management system can be activated. One or more additional conditions may be necessary for the buffer management system to control the host vehicle 100. For example, a velocity of the host vehicle may need to be less than a threshold, a number of surrounding road actors may need to be greater than a threshold, and/or one or more ADAS features (e.g., adaptive cruise control) may need to be enabled.

At 430, a cut-in status can be determined which represents whether one or more road actors 102 are cutting in between the host vehicle 100 and the lead vehicle 102. If, for example, a number of road actor cut-ins exceeds a threshold, then the method 400 can proceed to 440 where a first buffer or follow distance time can be generated. Additionally or alternatively, if an amount of time since the last road actor cut-in is less than a threshold, then the method 400 can proceed to 440 where the first buffer or follow distance time can be generated.

At 442, the first buffer, which accounts for one or more road actor cut-ins, can be generated. According to one aspect, the first buffer time can include a preferred follow distance time of the driver and a cut-in buffer time. The cut-in buffer time can be a calibrated amount of time.

At 444, one or more conditions can be evaluated to determine whether the first buffer should be absorbed. If, for example, the lead vehicle 102 decelerates abruptly, the first buffer can be absorbed (i.e., removed) to allow the host vehicle 100 to utilize a less aggressive deceleration profile than the lead vehicle 102. According to one aspect, the first buffer should be absorbed if one or more of the following thresholds are met: the velocity of the host vehicle 100 with respect to the lead vehicle 102 is less than a first buffer threshold, the absolute velocity of the lead vehicle 102 with respect to the road is less than a second buffer threshold, the acceleration of the lead vehicle 102 with respect to the host vehicle 100 is less than a third buffer threshold, or whether the velocity of the host vehicle 100 with respect to the road is less than a fourth buffer threshold.

At 446, the first buffer is absorbed and the preferred follow distance time is maintained.

At 448, one or more conditions can be evaluated to determine whether the first buffer should be increased. If, for example, the lead vehicle 102 accelerates abruptly and pulls away from the host vehicle 100, the first buffer can be reestablished. According to one aspect, the first buffer should be reestablished if one or more of the following thresholds are met: the velocity of the host vehicle 100 with respect to the lead vehicle 102 is greater than the first buffer threshold, the absolute velocity of the lead vehicle 102 with respect to the road is greater than the second buffer threshold, the acceleration of the lead vehicle 102 with respect to the host vehicle 100 is greater than the third buffer threshold, or whether the velocity of the host vehicle 100 with respect to the road is greater than the fourth buffer threshold.

At 442, the first buffer can be reestablished.

Returning to 430, if the number of road actor cut-ins is less than the threshold then the method 400 can proceed to 450 where a second buffer or follow distance time can be generated. Additionally or alternatively, if an amount of time since the last road actor cut-in is greater than the threshold then the method 400 can proceed to 450 where the second buffer or follow distance time can be generated.

At 452, the second buffer can be generated assuming road actor cut-ins are not present. According to one aspect, the second buffer time can include a preferred follow distance time of a non-cut-in buffer time. The non-cut-in buffer time can be a calibrated amount of time.

At 454, one or more conditions can be evaluated to determine whether the second buffer should be absorbed. If, for example, the lead vehicle 102 decelerates abruptly, the second buffer can be absorbed (i.e., removed) to allow the host vehicle 100 to utilize a less aggressive deceleration profile than the lead vehicle 102. According to one aspect, the second buffer should be absorbed if one or more of the following thresholds are met: the velocity of the host vehicle 100 with respect to the lead vehicle 102 is less than a fifth buffer threshold, the absolute velocity of the lead vehicle 102 with respect to the road is less than a sixth buffer threshold, the acceleration of the lead vehicle 102 with respect to the host vehicle 100 is less than a seventh buffer threshold, or whether the velocity of the host vehicle 100 with respect to the road is less than an eighth buffer threshold.

At 456, the second buffer is absorbed and the preferred follow distance time is maintained.

At 458, one or more conditions can be evaluated to determine whether the second buffer should be reestablished (i.e., increased). If, for example, the lead vehicle 102 accelerates abruptly and pulls away from the host vehicle 100, the second buffer can be reestablished. According to one aspect, the second buffer should be reestablished if one or more of the following thresholds are met: the velocity of the host vehicle 100 with respect to the lead vehicle 102 is greater than the fifth buffer threshold, the absolute velocity of the lead vehicle 102 with respect to the road is greater than the sixth buffer threshold, the acceleration of the lead vehicle 102 with respect to the host vehicle 100 is greater than the seventh buffer threshold, or whether the velocity of the host vehicle 100 with respect to the road is greater than the eighth buffer threshold.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method that, when executed by data processing hardware, causes the data processing hardware to perform operations comprising:
gathering sensor data from a sensor system of a host vehicle;
evaluating the sensor data;
determining surrounding road conditions and behavior of a lead vehicle;
receiving a first follow gap selected by a driver;
calculating a second follow gap based on the surrounding road conditions and the behavior of the lead vehicle;
adjusting an acceleration profile of the host vehicle using the second follow gap while maintaining at least the first follow gap between the host vehicle and the lead vehicle;
monitoring behavior of road actors in one or more adjacent lanes; and
adjusting the second follow gap based on the behavior of the road actors in the one or more adjacent lanes.

2. The method of claim 1, wherein the surrounding road conditions and behavior of the lead vehicle further comprises evaluating a host vehicle velocity, a first target follow distance time, and a rate of change of the host vehicle with a road condition assessment module.

3. The method of claim 2, wherein the road condition assessment module is configured to provide an adjusted time gap.

4. The method of claim 3, wherein calculating the second follow gap further comprises evaluating the adjusted time gap, the first follow gap, and a minimum allowable gap with a buffer evaluation module.

5. The method of claim 4, wherein the buffer evaluation module is configured to provide a second target follow distance time.

6. The method of claim 5, wherein calculating the second follow gap further comprises evaluating the second target follow distance time and an oscillatory gain with a predictive logic module.

7. The method of claim 1, wherein the second follow gap is continuously calculated according to the surrounding road conditions and behavior of the lead vehicle.

8. The method of claim 7, wherein the second follow gap is reduced when one or more road actors cut in between the lead vehicle and the host vehicle.

9. The method of claim 8, wherein the second follow gap is increased when road conditions are highly variable.

10. The method of claim 9, wherein the second follow gap is maintained when road conditions are consistent.

11. A system comprising:
data processing hardware; and
memory hardware in communication with the data processing hardware, the memory hardware storing instructions that, when executed on the data processing hardware, cause the data processing hardware to perform operations comprising:
gathering sensor data from a sensor system of a host vehicle;
evaluating the sensor data;
determining surrounding road conditions and behavior of a lead vehicle;
receiving a first follow gap selected by a driver;
calculating a second follow gap based on the surrounding road conditions and the behavior of the lead vehicle;
adjusting an acceleration profile of the host vehicle using the second follow gap while maintaining at least the first follow gap between the host vehicle and the lead vehicle;
monitoring behavior of road actors in one or more adjacent lanes; and
adjusting the second follow gap based on the behavior of the road actors in the one or more adjacent lanes.

12. The system of claim 11, wherein the second follow gap is continuously calculated according to the surrounding road conditions and behavior of the lead vehicle.

13. The system of claim 12, wherein the second follow gap is reduced when one or more road actors cut in between the lead vehicle and the host vehicle.

14. The system of claim 13, wherein the second follow gap is increased when road conditions are highly variable.

15. The system of claim 14, wherein the second follow gap is maintained when road conditions are consistent.

16. A computer-implemented method that, when executed by data processing hardware, causes the data processing hardware to perform operations comprising:
determining a traffic condition status;
disabling a buffer management system if the traffic condition status indicates consistent traffic surrounding a host vehicle;
activating the buffer management system if the traffic condition status indicates variable traffic surrounding the host vehicle;
determining whether road actor cut-ins are present between the host vehicle and a lead vehicle; and
either generating (i) a first buffer if the road actor cut-ins are present or (ii) a second buffer if the road actor cut-ins are not present.

17. The method of claim 16, wherein the first buffer further comprises a preferred follow distance time and a cut-in buffer time.

18. The method of claim 17, wherein the cut-in buffer time can be absorbed if one or more thresholds are met and reestablished if the one or more thresholds are not met.

19. The method of claim 16, wherein the second buffer further comprises a preferred follow distance time and a non-cut-in buffer time.

20. The method of claim 19, wherein the non-cut-in buffer time can be absorbed if one or more thresholds are met and reestablished if the one or more thresholds are not met.
